(19) United States
(12) Patent Application Publication
(10) Pub. No.: US 2013/0308709 A1
(43) Pub. Date: Nov. 21, 2013

(54) TILE SIZE IN VIDEO CODING

(71) Applicant: TELEFONAKTIEBOLAGET L M ERICSSON (PUBL), Stockholm (SE)

(72) Inventors: Andrey NORKIN, Solna (SE); Rickard SJOBERG, Stockholm (SE)

(73) Assignee: TELEFONAKTIEBOLAGET L M ERICSSON (PUBL), Stockholm (SE)

(21) Appl. No.: 13/671,991

(22) Filed: Nov. 8, 2012

Related U.S. Application Data
(60) Provisional application No. 61/557,093, filed on Nov. 8, 2011.

(51) Int. Cl. H04N 7/26

(52) U.S. Cl. CPC H04N 19/00
USPC 375/240.25; 375/240.01; 375/240.29

(57) ABSTRACT

A video encoder arranged to encode a video sequence, the video encoder comprising: a partitioning module arranged to partition the video sequence into tiles, wherein the tile size is greater than a predetermined minimum tile size; and at least one encoding module arranged to encode the tiles.

This application claims the benefit from U.S. Provisional No. 61/557,093, filed 11 Nov. 2011, the entire contents of which is hereby incorporated by reference.

### TECHNICAL FIELD

The present application relates to a video encoder, a method in a video encoder, a video decoder, a method in a video decoder, and a computer-readable medium.

### BACKGROUND

High Efficiency Video Coding (HEVC) is a draft video compression standard, and a successor to H.264/MPEG-4 AVC (Advanced Video Coding). HEVC is developed jointly by the ISO/IEC Moving Picture Experts Group (MPEG) and ITU-T Video Coding Experts Group (VCEG) as ISO/IEC 23008-2 MPEG-H Part 2 and ITU-T H.HEVC.

The core of the coding layer in previous standards was the macroblock, containing a 16×16 block of luma samples and, in the usual case of 4:2:0 color sampling, two corresponding 8×8 blocks of chroma samples; whereas the analogous structure in HEVC is the coding tree unit (CTU), which has a size selected by the encoder and can be larger than a traditional macroblock. The CTU consists of a luma coding tree block (CTB) and the corresponding chroma CTBs and syntax elements. The size L×L of a luma CTB can be chosen as L=16, 32, or 64 samples, with the larger sizes typically enabling better compression. HEVC then supports a partitioning of the CTBs into smaller blocks using a tree structure and quadtree-like signaling.

The quadtree syntax of the CTU specifies the size and positions of its luma and chroma coding blocks (CBs). The root of the quadtree is associated with the CTU. Hence, the size of the luma CTB is the largest supported size for a luma CB. The splitting of a CTU into luma and chroma CBs is signaled jointly.

One luma CB and ordinarily two chroma CBs, together with associated syntax, form a Coding Unit (CU). A CTB may contain only one CU or may be split to form multiple CUs, and each CU has an associated partitioning into prediction units (PUs) and a tree of transform units (TUs).

The decision whether to code a picture area using inter-picture or intra-picture prediction is made at the CU level. A prediction unit (PU) partitioning structure has its root at the CU level. Depending on the basic prediction type decision, the luma and chroma CBs can then be further split in size and predicted from luma and chroma prediction blocks (PBs). HEVC supports variable PB sizes from 64×64 down to 4×4 samples.

Where reference is made below to a coding unit (CU), this may refer to either a luma or chroma coding block (CB), or even both. The coding unit of HEVC is analogous to the macroblock used in other video coding standards.

The H.264 video coding standard defines so-called profiles and levels. A profile is a subset of coding tools specified in the standard that is generally targeted to a particular set of applications. There are several profiles in H.264 such as Baseline profile (targeted to conferencing and mobile applications), Main profile (targeted to television) and High profile (targeted coding of higher resolution of video). It might not be practical to demand from the decoder to implement the decoding abilities to decode all possible combinations of picture sizes and bitrates within the chosen profile. For that reason, the “levels” in H.264 are specified. The levels impose constraints on values of syntax elements allowed in the profile such as bitrate or picture sizes.

Separately, a tool called “Tiles” has recently been adopted into the High Efficiency Video Coding (HEVC) standard. This tool changes the decoding order of the Largest Coding Units (LCUs, alternatively Largest Tree Blocks (LTBs), or Coding Tree Units (CTUs)). The tiles can be explained as picture areas defined by a set vertical and/or horizontal lines dividing the picture into rectangles. These rectangles are the tiles. LCUs are decoded in raster scan order inside each tile and the tiles are decoded in the raster scan order inside a picture. Compared to the normal raster scan decoding order, tiles affect the availability of the neighboring coding units (or tree blocks) for prediction and may or may not include resetting any entropy coding.

FIG. 1 shows an example of Tile partitioning using three columns separated by column boundaries 110 and three rows separated by row boundaries 120. FIG. 1 shows a plurality of LCUs 100, the first 41 of which are numbered.

FIG. 2 shows an example of Tile partitioning using three columns, separated by column boundaries 210 and one row. The columns are separated into slices by a slice boundary 230. FIG. 2 shows a plurality of LCUs 200, the first 14 of which are numbered.

Each tile contains an integer number of LCUs. LCUs are processed in raster scan order within each tile and the tiles themselves are processed in raster scan order within the picture. Slice boundaries are introduced by the encoder.

Partitioning a picture into slices as part of the encoding process is known to negatively impact coding efficiency particularly when the slices are designed to be independently decodable. However, many applications and implementations now require the partitioning of a picture. For example:
Parallel processing: some implementations such as those executed on modern multi-core CPUs, partition a source picture into slices and send each slice to a separate core to be encoded in parallel. High quality real-time encoding of high definition video (e.g., 1280×720 and larger) would not be possible today on a general-purpose multi-core CPU without partitioning and parallel encoding. In addition, to reduce costly information sharing between cores during the encoding/decoding process, it is typically advantageous for slices to be coded independently.
MTU size matching: when transporting a coded bitstream on an IP network, packets are subject to a maximum transmission unit (MTU) size. If a packet contains many fewer bits than the MTU size, then packet header bit overhead can significantly affect coding efficiency. However, if a packet contains more bits than the MTU size, the network will fragment the packet. Further, a lost packet fragment results in an error resilience problem since the entire packet is unrecoverable if one fragment is lost. One way to avoid packet fragmentation is to partition the picture into one or more slices, put each slice in a separate packet while making sure that each packet is smaller than the MCU size.
Error resilience: some applications partition pictures into independently decodable slices and apply unequal error protection techniques to protect slices deemed more important.

One important aspect when considering practical implementation of the video coding in hardware is the memory bandwidth. In order to decrease the number of read and write accesses made to memory, the macro-block order decoding is used in H.264. In that case, the block is reconstructed, then the deblocking is applied for the internal block boundaries and then deblocking is applied to the boundaries with already reconstructed blocks. After all of this the block is written back to the memory. However, the deblocking cannot be applied to boundaries with blocks that have not been reconstructed yet. Therefore, the pixels that are not yet processed by the deblocking filter are kept in the buffer memory, sometimes referred to as the line buffer. Since macroblocks are processed in the raster scan order, the pixels in the boundary region on the right macroblock boundary must be kept in the memory until the next macroblock to the right is reconstructed and the deblocking can be applied. However, for the bottom macroblock boundary, the information about the reconstructed pixels has to be kept in the buffer memory until the macroblock in the next row is reconstructed and processed.

If, for example, the deblocking filter across macroblock boundaries uses four pixels from each side of the boundary, then four lines of pixels along the bottom boundary needs to be stored until the next macroblock row is being reconstructed. In that case the amount of buffer memory required is 4 lines of picture width. The buffer memory needed can amount to a significant amount of memory, particularly for high resolution video, which means higher hardware costs for the decoder (since the buffer memory is on-chip and so significantly more expensive than off-chip memory).

Herein, the term “boundary layer” is used to denote the amount of pixels that are needed to be stored in a deblocking process as described above. The boundary layer of a block comprises a plurality of pixels, the values of which are used by the de-blocking filter during the decoding of a subsequent block.

In HEVC, the problem with line buffer requirements becomes even more important, since the HEVC standard targets resolutions higher than the current definition of High Definition (1920 by 1080 pixels). Moreover, HEVC also has other in-loop filters than the deblocking filter, for example, sample adaptive offset (SAO) and adaptive loop filter (ALF). These loop filters are applied on top of the deblocking filter and introduce a further increase of the required line buffer size, since the pixels at the bottom boundary of LCU (Largest Coding Unit) have not been yet processed by the deblocking and therefore cannot be used as input to SAO and ALF. Therefore, the line buffer for a HEVC decoder must have more lines than H.264, which together with greater picture width requires far more on-chip memory to be provided for line buffers.

“Working Draft 4 of High-Efficiency Video Coding”, JCTVC-F803, Italy, July 2011 gives a general description of the HEVC standard, currently still a work in progress.

Arild Fuldseth, Michael Horowitz, Shilin Xu, Andrew Segall, Minhua Zhou, “Tiles”, JCTVC-F335, Italy, July 2011 provides a description of the coding technique referred to as “Tiles”.

### SUMMARY

A concept introduced herein is to restrict the minimum tile size for the HEVC levels of video. Additional line memory may be required for the columns nearest to the right boundary of the tile. That is, there may be an additional boundary region of a number of pixel columns at the right boundary of a tile. (The pixel values of these columns needs to be stored until the tile to the right has been decoded (but not deblocked) since pixel values from each side of the boundary are needed in order to correctly deblock the boundary.) However, this additional line memory only needs to be accessed once per tile, and so it can be kept in the off-chip memory of the decoder and read when needed without significantly increasing the memory bandwidth. This approach could cause a delay if the tile width is too small, but this problem can be overcome by imposing a limitation on the minimum tile width.

A further concept introduced herein is to restrict the maximum tile size for the HEVC levels of video. This will limit the amount of on-chip memory that is required for in-loop filtering (and also for intra-prediction), which means that the encoded video stream may be decoded by a decoder having a smaller capacity line buffer and thus lower manufacturing cost. Thus, there is provided a video encoder arranged to encode a video sequence, the video encoder comprising a portioning module and at least one encoding module. The partitioning module is arranged to partition the video sequence into tiles, wherein the tile size is greater than a predetermined minimum tile size. The at least one encoding module is arranged to encode the tiles.

The encoder may be arranged to optimize encoding for a particular video decoder, the particular decoder arranged to store the right boundary of a tile in off-chip memory. Setting a minimum tile size imposes an upper limit on the frequency with which the off-chip memory must be accessed. This reduces the impact of any delay caused by accessing the off-chip memory.

The tile size may be at least one of: tile height; tile width, tile area, and tile perimeter.

There is further provided a method in a video encoder, the method comprising partitioning the video sequence into tiles, wherein the tile size is greater than a predetermined minimum tile size. The method further comprising encoding the tiles.

There is further provided a video decoder arranged to decode an encoded video sequence, the video sequence encoded in tiles, the video decoder comprising a coding unit and a de-blocking filter. The coding unit decoding module is arranged to decode coding units of pictures in the encoded video sequence. The de-blocking filter is arranged to smooth the boundaries between coding units, wherein the de-blocking filter accesses the right boundary of a tile stored in an off-chip memory.

There is further provided a method in a video decoder, the video decoder arranged to decode an encoded video sequence, the video sequence encoded in tiles. The method comprises decoding coding units of pictures in the encoded video sequence. The method further comprises smoothing the boundaries between coding units using a de-blocking filter, wherein the de-blocking filter accesses the right boundary of a tile stored in an off-chip memory.

There is also provided a computer-readable medium, carrying instructions, which, when executed by computer logic, causes said computer logic to carry out any of the methods defined herein.

### BRIEF DESCRIPTION OF THE DRAWINGS

A method and apparatus for restricting the tile size in video coding will now be described, by way of example only, with reference to the accompanying drawings, in which:

FIG. 1 shows a first example of tile partitioning;

FIG. 2 shows a second example of tile partitioning;

FIG. 3 shows a video encoder;

FIG. 4 shows a video decoder;

FIG. 5 illustrates a method of encoding a video sequence; and

FIG. 6 illustrates a method of decoding a video sequence.

### DETAILED DESCRIPTION

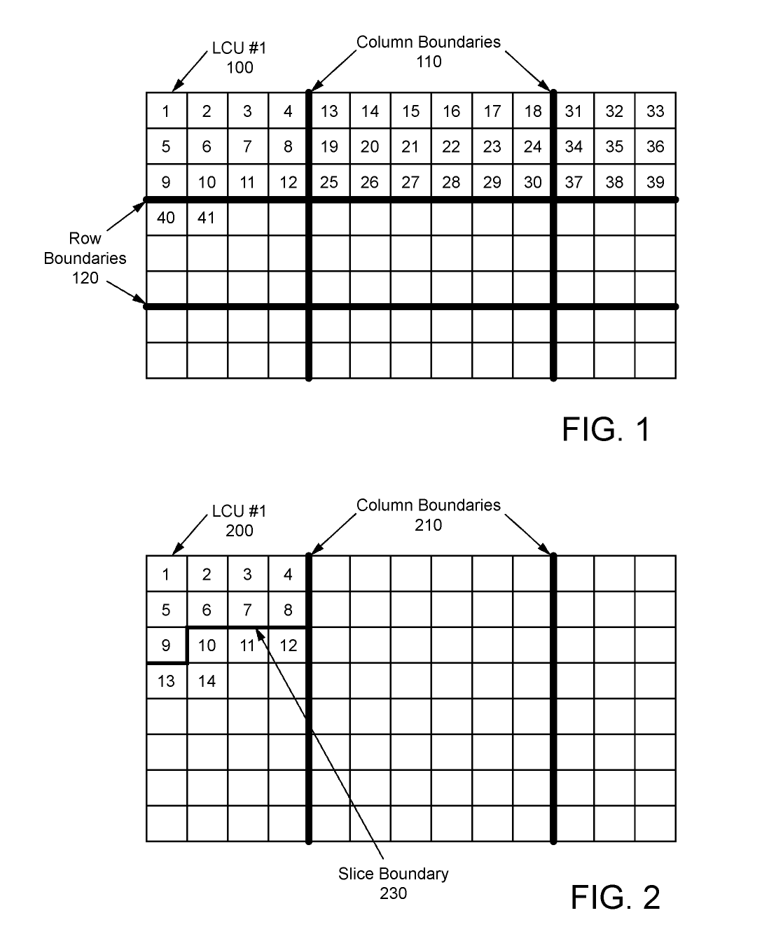

As apparent from FIGS. 1 and 2, if the decoding and filtering are performed in the tile order, then only the pixel values in the boundary region of a tile have to be kept in the on-chip memory. This is in contrast to the decoding and filtering of a non-tiled picture whereby the boundary region of lines of the full picture width must be stored in the line buffer. Therefore, less buffer memory is required where tiles are employed. The method and apparatus described herein thus makes tiles obligatory for certain profiles and levels and also imposes a limitation of the maximum tile width.

In some embodiments some additional line memory might be required for the columns nearest to the right boundary of the tile. That is, there may be an additional boundary region of a number of pixel columns at the right boundary of a tile. However, this additional line memory only needs to be accessed once per tile, and so it can be kept in the off-chip memory of the decoder and read when needed without significantly increasing the memory bandwidth. This approach could cause a delay if the tile width is too small, but this can be counteracted by imposing a further limitation on the minimum tile width.

Having several tiles vertically (as in FIG. 1) also requires loading the on-chip memory more often when switching back between the tile rows. Therefore, a limitation on the minimum vertical tile size can also be imposed to counteract any delay created by this.

The size of the Largest Coding Unit is determined by the tile area, which is equal to tile_width*tile_height. The tile size can be limited by application of a limit to the number of LCUs in a tile. Minimum and maximum values for LCU number could be specified for each level of coding.

Another alternative is to limit the value of the sum tile_width+tile_height, since it determines the size of on chip-memory required in the decoder. Therefore, it is also possible to limit the tile_width+tile_height sum value with maximum or minimum values (or both minimum and maximum values).

The constraints on tile size may be expressed in height in number of LCUs, width in number of LCUs or number of LCU's in tile (tile_width_in_LCU*tile height_in_LCU). These constraints may also be expressed in pixels.

In a first embodiment a limit of maximum_tile_width is applied to every level (or for a subset of levels).

In a second embodiment a limit of maximum_tile height is applied to every level (or for a subset of levels).

In a third embodiment a limit of minimum_tile_width is applied to every level (or for a subset of levels).

In a fourth embodiment a limit of minimum_tile height is applied to every level (or for a subset of levels).

In a fifth embodiment a limit of maximum_tile_width and maximum_tile height is applied to every level (or for a subset of levels).

In a sixth embodiment a limit of minimum_tile_width and minimum_tile height is applied to every level (or for a subset of levels).

In a seventh embodiment a limit of maximum of tile_width*tile_height is applied to every level (or for a subset of levels).

In a eighth embodiment a limit of minimum of tile_width*tile_height is applied to every level (or for a subset of levels).

In a ninth embodiment a limit of maximum tile_width*tile_height and the minimum tile_width*tile_height is applied to every level (or for a subset of levels).

In a tenth embodiment a limit of maximum tile_width+tile_height is applied to every level (or for a subset of levels).

In an eleventh embodiment a limit of minimum tile_width+tile_height is applied to every level (or for a subset of levels).

In a twelfth embodiment a limit of maximum tile_width+tile_height and the minimum tile_width+tile_height is applied to every level (or for a subset of levels).

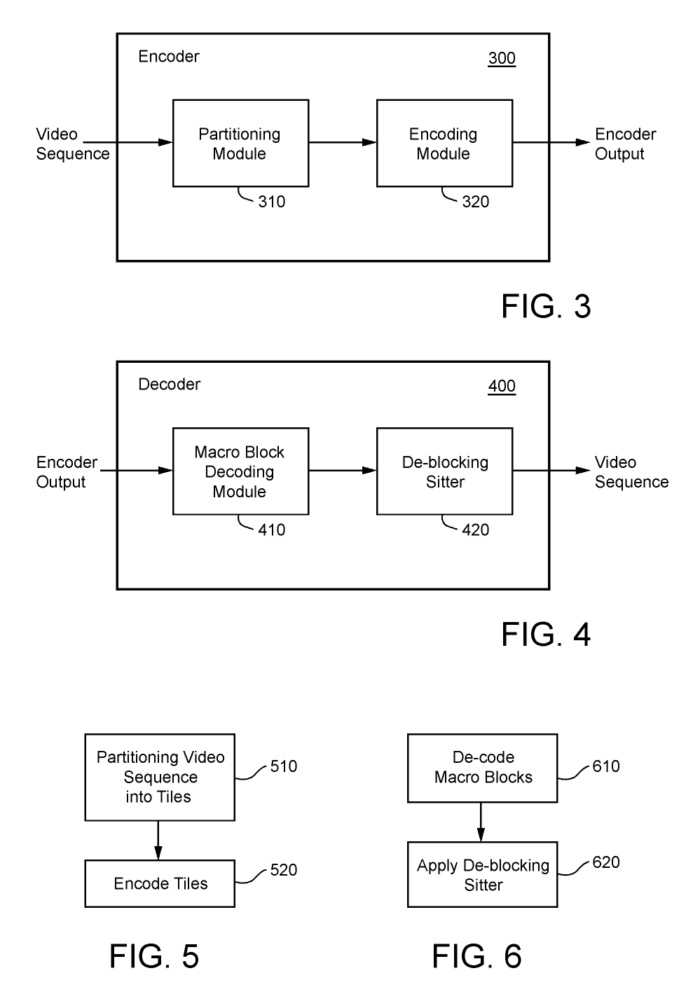

FIG. 3 shows a video encoder 300. The video encoder comprises a partitioning module 310 and an encoding module 320. The partitioning module 310 receives a video sequence and partitions the pictures of the video sequence into tiles. The tiles are encoded by the encoding module 320, and the encoded modules are output from the encoder 300.

FIG. 4 shows a video decoder 400. The video decoder 400 comprises a coding unit decoding module 410 and a de-blocking filter 420. The coding unit decoding module 410 receives the encoder output, which may be transmitted from the encoder to the decoder by any communications network. The coding unit decoding module 410 decodes the coding units of each picture of the video sequence as part of the video decoding process. The decoded coding units are passed through a de-blocking filter 420 which smoothes the edges of the coding units removing any encoding artifacts that may have been introduced during the encoding process. The output of the de-blocking filter is the video sequence, which may be output to a display.

FIG. 5 illustrates a method of encoding a video sequence. The method comprises partitioning 510 a video sequence into tiles. The tiles are then encoded 520, using a block based encoding scheme. At least one dimension of the tile is controlled as described herein to facilitate optimal decoding at a decoder.

FIG. 6 illustrates a method of decoding a video sequence. The method comprises decoding 610 coding units from an encoded video sequence. The method further comprises applying 620 a de-blocking filter to the coding units to smooth any encoding artifacts. The decoder will include a means to temporarily store pixel values for boundary regions of preceding tiles so that these may be used for the smoothing operation at the edges of the tile currently being decoded.

The methods and apparatuses disclosed herein make it possible to decrease the amount of on-chip memory needed for the line buffer in a video decoder. This makes the encoder less expensive and easier to implement.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

Further, while examples have been given in the context of particular video coding standards, these examples are not intended to be the limit of the video coding standards to which the disclosed method and apparatus may be applied. For example, while specific examples have been given in the context of HEVC, the principles disclosed herein can also be applied to any H.264 system, other video coding system, and indeed any video coding system which uses a line buffer.

There is provided a video encoder arranged to encode a video sequence, the video encoder comprising: a partitioning module arranged to partition the video sequence into tiles, wherein the tile size is less than a predetermined maximum tile size; and at least one encoding module arranged to encode the tiles.

The encoder may be arranged to optimize encoding for a particular video decoder. The predetermined maximum tile size may be determined such that a de-blocking filter in the particular video decoder has sufficient buffer memory to store pixel values for a boundary layer of a tile having the maximum tile size.

The maximum tile size may be dependent upon the level of encoding quality.

The partitioning module may be further arranged to determine a picture width of the video sequence and to partition the video sequence into tiles if the picture width exceeds a predetermined maximum tiles size.

The tile size may be greater than a minimum tile size.

The tile size may be at least one of: tile height; tile width, tile area, and tile perimeter.

There is further provided a method in a video encoder, the method comprising: partitioning the video sequence into tiles, wherein the tile size is less than a predetermined maximum tile size; and encoding the tiles.

The method may further comprise optimizing encoding for a particular video decoder whereby the predetermined maximum tile size may be determined such that a de-blocking filter in the particular video decoder has sufficient buffer memory to store pixel values for a boundary layer of a tile having the maximum tile size.

There is further provided a video decoder arranged to decode an encoded video sequence, the video sequence encoded in tiles, the video decoder comprising: a coding unit decoding module arranged to decode coding units of pictures in the encoded video sequence; and a de-blocking filter arranged to smooth the boundaries between coding units, wherein the de-blocking filter comprises sufficient buffer memory to store pixel values for a boundary layer of a tile.

The boundary layer of a tile comprises a plurality of pixels, the values of which are used by the de-blocking filter during the decoding of a subsequent tile.

The video decoder may be arranged to receive an encoded video sequence, the encoded video sequence partitioned into tiles and encoded using a tile size suitable for the video decoder.

There is further provided a method in a video decoder, the video decoder arranged to decode an encoded video sequence, the video sequence encoded in tiles, the method comprising: decoding coding units of pictures in the encoded video sequence; and smoothing the boundaries between coding units using a de-blocking filter, wherein the de-blocking filter comprises sufficient buffer memory to store pixel values for a boundary layer of a tile.

There is further provided a computer-readable medium, carrying instructions, which, when executed by computer logic, causes said computer logic to carry out any of the methods defined herein.

1. A video encoder arranged to encode a video sequence, the video encoder comprising:
a partitioning module arranged to partition the video sequence into tiles, wherein the tile size is greater than a predetermined minimum tile size; and
at least one encoding module arranged to encode the tiles.

2. The video encoder of claim 1, wherein the encoder is arranged to optimize encoding for a particular video decoder, the particular decoder arranged to store the right boundary of a tile in off-chip memory.

3. The video encoder of claim 1, wherein the minimum tile size is dependent upon the coding profile and/or coding level.

4. The video encoder of claim 1, wherein the tile size is also less than a maximum tile size.

5. The video encoder of claim 1, wherein the partitioning module is further arranged to determine a picture width of the video sequence and to partition the video sequence into tiles if the picture width exceeds a predetermined maximum tiles size.

6. The video encoder of claim 1, wherein the tile size is at least one of: tile height; tile width, tile area, and tile perimeter.

7. A method in a video encoder, the method comprising:
partitioning the video sequence into tiles, wherein the tile size is greater than a predetermined minimum tile size; and
encoding the tiles.

8. The method of claim 7, the method further comprising:
optimizing encoding for a particular video decoder, the particular decoder arranged to store the right boundary of a tile in off-chip memory.

9. A video decoder arranged to decode an encoded video sequence, the video sequence encoded in tiles, the video decoder comprising:
a coding unit decoding module arranged to decode coding units of pictures in the encoded video sequence; and
a de-blocking filter arranged to smooth the boundaries between coding units, wherein the de-blocking filter accesses the right boundary of a tile stored in an off-chip memory.

10. The video decoder of claim 9, wherein the boundary layer of a tile comprises a plurality of pixels, the values of which are used by the de-blocking filter during the decoding of a subsequent tile.

11. The video decoder of claims 9, wherein the video decoder is arranged to receive an encoded video sequence, the encoded video sequence partitioned into tiles and encoded using a tile size suitable for the video decoder.

12. A method in a video decoder, the video decoder arranged to decode an encoded video sequence, the video sequence encoded in tiles, the method comprising:
decoding coding units of pictures in the encoded video sequence; and
smoothing the boundaries between coding units using a de-blocking filter, wherein the de-blocking filter accesses the right boundary of a tile stored in an off-chip memory.

13. The method of claim 12, wherein the off-chip memory is accessed once per tile.

14. The method of claim 12, wherein a minimum tile size is selected dependent upon the expected time delay to access the off-chip memory.

15. A computer-readable medium, carrying instructions, which, when executed by computer logic, causes said computer logic to carry out the method according to claim 7.
